(19) United States
(12) Patent Application Publication
(10) Pub. No.: US 2007/0289837 A1
(43) Pub. Date: Dec. 20, 2007

(54) Rotary Fluid Coupling

(75) Inventor: Jonnathan Charles Wheals, Warwickshire (GB)

Correspondence Address: OSHA LIANG L.L.P., 1221 MCKINNEY STREET, SUITE 2800, HOUSTON, TX, 77010, US

(73) Assignee: Ricardo UK Limited, West Sussex (GB)

(21) Appl. No.: 11/629,600

(22) PCT Filed: Jun. 16, 2005
(86) PCT No.: PCT/GB05/02367

§ 371 Date: Jun. 4, 2007

(30) Foreign Application Priority Data
Jun. 16, 2004 (GB) 0413464.9

(51) Int. Cl. F16D 37/00

(52) U.S. Cl. 192/84.81

(57) ABSTRACT

A fluid coupling containing a magnetically responsive fluid (27, 76) is in series with a digital clutch (71). Disengagement of the clutch (71) ensures that during times of no torque transmission, the fluid (27) does not cause parasitic drag, and is not subject to degradation because of continual shear. Wear of the necessary fluid seals (28) is also reduced.

This invention relates to rotary fluid couplings, and particularly to magnetic fluid couplings in which the degree of engagement of the magnetic fluid coupling is dependent upon the strength of a magnetic field. The invention is concerned with reducing parasitic drag in the coupling and degradation of the magnetically responsive fluid, at times when the coupling is not required to transmit torque.

Magnetically responsive fluids have the capability of changing state when subjected to an altered magnetic field. This reversible characteristic can be utilized in rotary couplings to couple a drive member to a reaction member on demand; the reaction member is usually a driven member. The fluid is typically a magnetically responsive powder or liquid, and may be a magneto-rheological liquid. Such couplings are advantageous where space constraints preclude mechanical or fluid actuated couplings with moving parts, a further reason being that provision of an electrical power supply, by e.g. flexible cable, is less problematic. Such couplings can be inexpensive, simple, have good frequency modulation (20 Hz or better), and low piece to piece variability; they are particularly attractive to vehicle designers, in cases where space is at a premium.

In a typical rotary coupling of this kind, a drive member and a reaction member are arranged in close proximity with a magnetically responsive fluid, such as a magneto-rheological liquid, therebetween and retained by suitable sealing arrangements. Typically, an electrical coil is energizable on demand to produce an altered magnetic field, which in turn causes particles in the fluid to become aligned to a degree dependent on the strength of the field. In effect the fluid may thicken or stiffen so as to allow drive to be transmitted to the reaction member. On removal of the magnetic field, drive substantially ceases as the fluid reverts to the passive state. The fluid may be a powder which will stiffen in the presence of a suitable magnetic field. Instead of an electro-magnet, a movable permanent magnet can be used to influence field strength.

Necessarily the drive and reaction members have a rather small clearance so as to minimize the maximum strength of the magnetic field which is required to cause full engagement of the coupling, and to minimize the volume of fluid required.

Magnetic fluid couplings have a number of advantages over conventional clutches, not least that there are no movable actuation components. However, there are several disadvantages. Firstly magnetic fluid couplings, like other kinds of fluid couplings, have parasitic drag when in the disengaged condition—this is an inevitable result of the magnetic fluid being in contact with both drive and reaction members. Secondly the magnetic fluid may degrade over time as a result of shear forces, and this degradation is exacerbated where only a small clearance is provided between the drive and reaction members. If this clearance is increased to reduce shear induced degradation, the result is that a stronger magnetic field is required for operational purposes.

What is required is a means of allowing minimum clearance and fluid quantity, whilst preventing fluid degradation.

According to a first aspect of the present invention there is provided a rotary coupling comprising a drive member and a reaction member having a gap therebetween, a magnetically responsive fluid in said gap, and apparatus for producing an altered magnetic field capable of changing the state of the fluid so as to transmit increased torque from the drive member to the reaction member on demand, wherein the coupling further includes a disengageable clutch in series with the drive member and operable on demand to obviate torque transmission from the drive member to the reaction member.

Accordingly the invention permits the coupling to be disengaged from the drive path when drive is not required. Thus the drive and reaction members of the coupling may be stationary, or may free-wheel so as to reduce fluid degradation to a minimum whilst the coupling is in the disengaged state. Furthermore the invention permits the clearance between the drive members to be reduced to the minimum commensurate with efficient operation, without regard to degradation losses when not transmitting torque. As a result closer clearances and a reduced fluid volume are possible, whilst reducing or substantially eliminating parasitic drag. The reaction member is typically a rotary driven member of the coupling.

A further advantage of the invention is that by substantially eliminating relative rotation of the drive members in the disengaged state, wear of the necessary fluid seals is substantially reduced.

Preferably the apparatus for producing an altered magnetic field is an electro-magnet, and the disengageable clutch is a digital clutch of the drive/no drive kind. Alternatively the digital clutch can be characterized as one in which energy absorption is substantially zero. In a preferred embodiment the digital clutch is at least partially, and preferably wholly, radially within the magnetic fluid coupling

The invention is suitable for modulating torque in many kinds of transportation device, including automobiles, off-highway vehicles, trucks, aircraft, watercraft, snowcraft and special purpose military equipment.

In a preferred embodiment, the coupling of the invention permits a variable torque bias to be applied to opposed drive shafts. Thus in a wheeled vehicle, the invention may be used to direct increased torque to a drive wheel so as to counteract understeer on cornering. In a tracked vehicle, the invention may be used to provide increased torque to the drive track on one side, so as to cause the vehicle to turn—this arrangement allows steering without the usual mechanical control linkage and/or brakes. In another example the invention may be used to generate resistance at the steering wheel for a vehicle having drive-by-wire steering, such resistance being dependent on an electrical feedback signal to a magnetic coupling.

In a preferred embodiment the digital clutch is a wrap spring, operable to transmit torque on demand. The wrap spring may for example have a grounding element engageable by operation of an electro-magnet, and may be bi-directional.

The magnetically responsive fluid is preferably either a magneto-rheological fluid or a magnetic powder.

In a preferred embodiment, the coupling further includes a reservoir for said fluid, and a collection device adapt to urge on demand substantially all of said fluid from said gap into said reservoir. The collection device may further include a magnetic attraction device to retain the fluid in the reservoir. In one embodiment the collection device comprises a deflector pivotable on demand from an inactive condition in which said fluid is undisturbed in said gap, to an active condition in which fluid is deflected into said reservoir during relative rotation between said drive member and reaction member.

According to a second aspect of the invention, there is provided a rotary coupling comprising a drive member, and a reaction member having a gap therebetween, a magnetically responsive fluid in said gap, and apparatus for producing an altered magnetic field capable of changing the state of the fluid so as to transmit increased torque from the drive member to the reaction member on demand, the coupling further comprising a reservoir for the fluid, and a collection device adapted to urge on demand substantially all of the fluid from the gap into the reservoir.

The collection device may be a means of generating an altered magnetic field, or may be a mechanical deflector movable from an inactive condition to an active condition whereby fluid is diverted into the reservoir, or may be a combination of both.

Other features of the invention will be apparent from the following description of a preferred embodiment shown by way of example only in the accompanying drawings, in which:

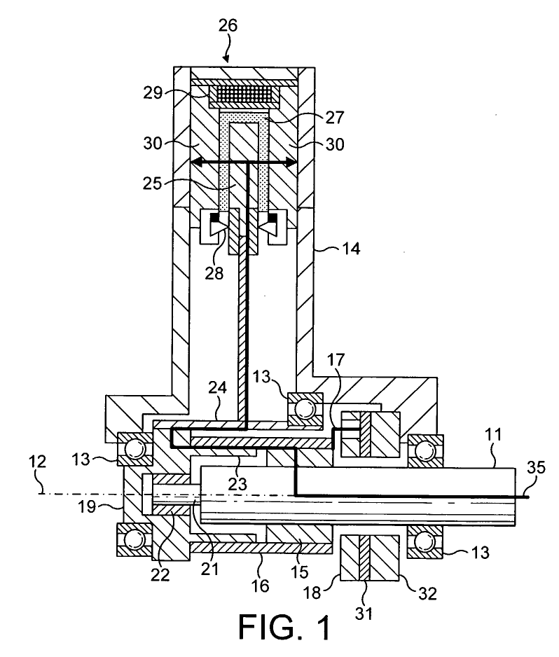

FIG. 1 is a schematic representation of a first (brake) embodiment of the invention;

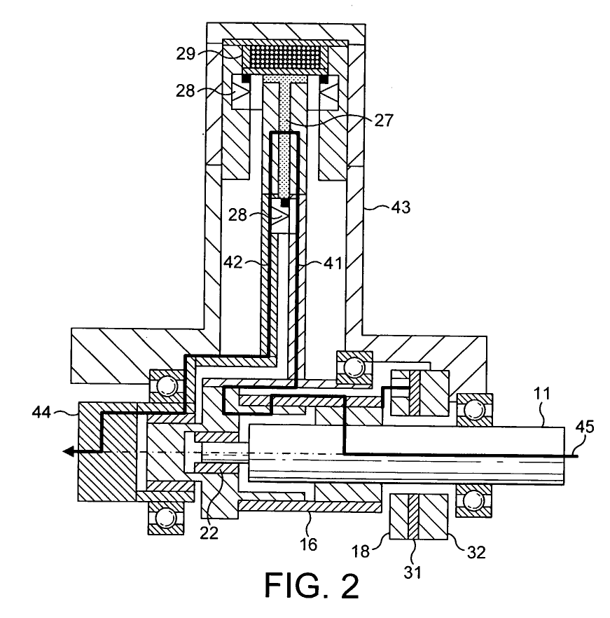

FIG. 2 is a schematic representation of a second (clutch) embodiment of the invention;

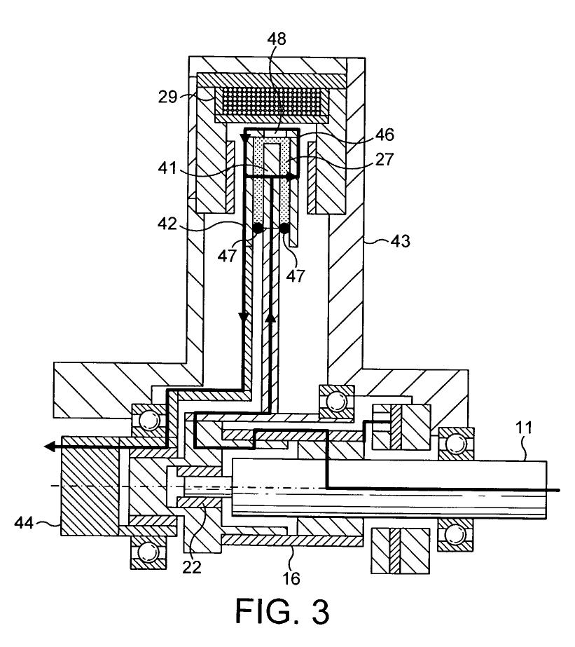

FIG. 3 is a schematic representation of a third (clutch) embodiment of the invention;

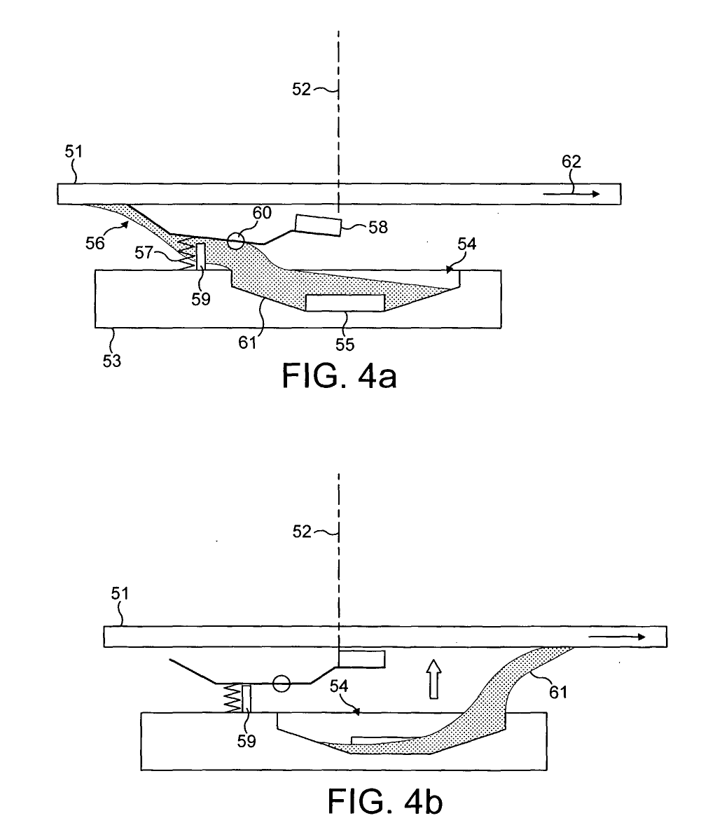

FIGS. 4a and 4B show a means of moving a rheological fluid to and from a reservoir;

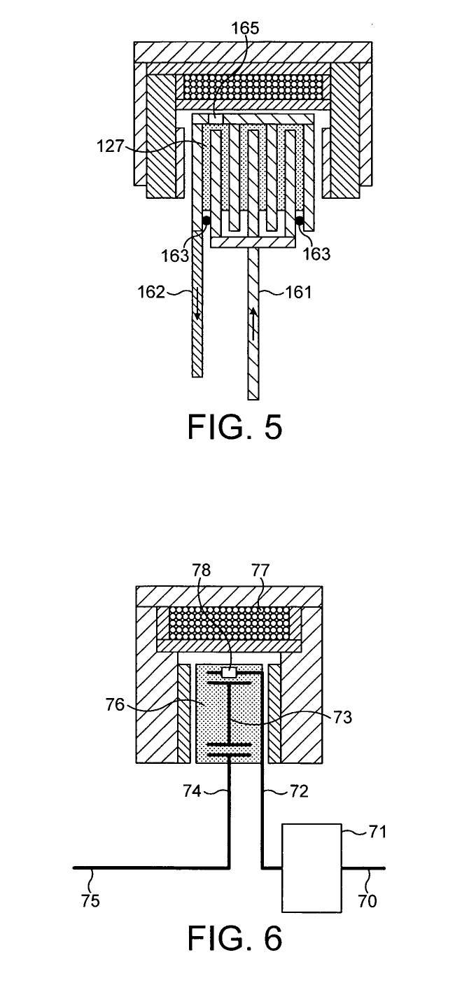

FIG. 5 shows a multi-plate coupling corresponding to the embodiment of FIG. 3; and

FIG. 6 shows a gear transmission having a magnetically responsive fluid operable to cause drive.

With reference to FIG. 1, an input drive member 11 is rotatable on an axis 12 within bearings 13 of a grounded casing 14. The casing is symmetrical about the axis 12, but for convenience parts of some of the components below the axis are eliminated.

The input drive member 11 has a cylindrical shoulder 15 around which is located a coil wrap spring 16, the tang 17 of which is retained in a rotatable tang ring 18 of ferro-magnetic material. Coaxial about the axis is an intermediate drive member 19 in which a stub axle 21 of the input drive member is journalled via a needle bearing 22. The intermediate drive member 19 has a concentric tubular projection 23 extending over the end of input drive member 11, and whose outer diameter is located within the wrap spring 16. The opposite side of drive member 19 is supported by a casing bearing 13.

As will be well understood by the skilled man, the wrap spring 16 allows slip between the input drive member 11 and the intermediate drive member 19 in one direction of rotation (as the coil tends to unwind) and drive in the other direction (as the coil tends to tighten).

The intermediate drive member is connected to a tube 24 having a circular radially extending flange which comprises the rotor 25 of the magnetic fluid coupling generally indicated by reference 26.

The casing 14 surrounds the rotor 25 as illustrated with a small clearance which is filled with a magnetically responsive fluid 27. Suitable seals 28 retain the fluid.

The radial extremity of the casing incorporates an electrical coil 29 having opposed poles 30, and which can be energized to change the state of the fluid 27.

The tang ring 18 rubs against a slip ring 31, e.g. of Mylar (TM), on the other side of which is an electrical coil 32 which is fixed with respect to the casing 14. When the coil 32 is energized, the tang ring 18 is attracted so as to cause drag between the rotating tang ring 18 and casing 14.

Operation of the device is as follows:

If no drive is required to the casing 14, neither coil 29,32 is energized. The input shaft 11 rotates, but no drive is transmitted via the wrap spring 16 to the rotor 25. Accordingly the rotor 25 and casing 14 are stationary. The wrap spring 16 may tend to rotate with the input shaft 11.

When solenoid 32 is activated, the resulting magnetic field causes the tang ring 18 to be attracted, and drag with respect to the casing 14, thus tightening the wrap spring 16 around the shoulder 15 and projection 23. Drive to the rotor 25 is very quickly effected because the wrap spring tightens to engage the components almost instantaneously. The magnetic coupling 26 is now in a condition to transmit drive according to the magnetic flux generated by energization of the coil 29. Thus the coupling 26 can be clutched into the drive train only when required, and unnecessary parasitic drag and degradation of performance is avoided. The torque path is indicated by solid line 35.

In this embodiment, the casing 14 is grounded, so that the coupling 26 acts as a brake for the shaft 11. The braking torque generated is a function of the magnetic flux generated by coil 29.

An alternative arrangement is illustrated in FIG. 2, in which corresponding parts are given the same reference numerals. The arrangement is very similar to that of FIG. 1, except that a drive rotor 41 and a driven rotor 42 are rotatable within a relatively stationary casing 43. The rotors 41,42 have a magnetically responsive fluid 27 therebetween which can be influenced by coil 29 to cause drive to be transmitted therebetween. The driven rotor 42 is connected to an output shaft 44 which is rotatable within the casing 43 and co-axial with the input shaft 11, as illustrated.

Operation of the embodiment of FIG. 2 is the same as described for FIG. 1, save that output drive is via shaft 44. The torque path is indicated by solid line 45, and the coupling is typically used as variable torque clutch.

FIG. 3 shows an alternative arrangement having greater torque capacity, but otherwise similar to FIG. 2; corresponding parts have the same reference numerals. In FIG. 3, the driven rotor 42 extends on both sides of the drive rotor 41 by virtue of a portion 46 hooking around the periphery of the drive rotor 41 as illustrated. As a result, the number of shear surfaces is doubled, and the radially outer fluid seal interface is eliminated, leaving just radially inner seals 47. In order to ensure that the lines of magnetic flux pass through the fluid 27, a flux breaker 48 is incorporated in the portion 46. The flux breaker should be of non-ferrous material, such as aluminium.

FIGS. 4a and 4b illustrates an apparatus for reducing drag still further.

A drive rotor 51 has a rotational axis 52. Adjacent the rotor 51 is a stator 53 defining a well 54 within which is provided an electrical coil 55. Mounted on the stator is a pivoting deflector 56 having one end lightly biased by spring 57 against the rotor 51 (FIG. 4a). The other end of the deflector comprises a metal mass 58 which is repelled on energization of the coil 55, to the position illustrated in FIG. 4b. An abutment 59 limits movement of the deflector 56 about the pivot 60 to the disengaged condition.

A magnetically responsive fluid 61 is provided adjacent the rotor 51 for the purposes of transmitting drive in the manner explained by reference to FIGS. 1-3. The normal direction of rotor rotation is indicated by arrow 62.

The embodiment of FIGS. 4a and 4b works as follows:

In the passive state (FIG. 4a), the deflector lightly rubs against the rotating rotor to deflect fluid into the well 54. The shape of the well is preferably designed to hold the fluid 61 without further measures, for example by relying upon viscous effects. Alternatively an electrical coil may be provided in the vicinity of the well to attract and or retain the fluid in the well on demand. Yet another possibility is to provide a permanent magnet to attract and or retain the fluid in the well, this magnet being movable from a passive to an active condition as required.

Energization of the coil 55 causes the mass 58 to be repelled (FIG. 4b) so that the deflector 56 disengages the rotor. Fluid 61 is thus allowed to escape from the well 54 and return to the vicinity of the rotor 51—a fluid retaining coil (if provided) is of course de-energized to permit the fluid to return.

The arrangement of FIGS. 4a and 4b allows the clutch of FIGS. 1-3 to be eliminated since removal of the magnetically responsive fluid to a reservoir will naturally prevent any parasitic drag losses, or degradation due to continual shear.

In an alternative, the deflector may be biased to the passive condition, and energized by a coil or permanent magnet into the active condition. Furthermore, the deflector and well may in the alternative be provided on the rotor, so as to move the fluid on demand from the interface with the stator.

FIG. 5 illustrates schematically how an increase in torque capacity can be achieved by using a stack of multiple thin plates of a drive rotor 61 interleaved with corresponding plates of a driven rotor 62. The sealing arrangements 63 are simplified (as in the embodiment of FIG. 3). A flux breaker 65 is incorporated as illustrated.

FIG. 6 shows an alternative arrangement in which a driving shaft 70 is connected via a digital clutch 71 to the annulus 72 of an epicyclic gear train. Planet wheels 73 are engaged to a sun gear 74 which in turn is connected to a driven shaft 75.

A magnetically responsive fluid 76 surrounds the elements of the epicyclic train and can be stiffened on energization of a coil 77, so as to cause torque to be transmitted from input to output. A flux breaker 78 is incorporated.

In operation, drive fails to be transmitted when the coil is not energized. However on energization, the fluid 76 stiffens and causes an increase in drag (for example drag of the planet carrier) and thus drive is transmitted from the annulus 72 to the sun gear 74. The digital clutch 71 allows disengagement of the epicyclic train when not required, so as to avoid parasitic drag losses and degradation of the fluid 76.

Fluid ducts may be provided, as required, to allow circulation of a coiling medium for the purposes of removing unwanted heat from the couplings described herein.

In this specification, the terms drive and driven member are used interchangeably, and the skilled man will understand that reverse torque transmission is possible. Furthermore although radial fluid gaps are described, circumferential gaps (as in a drum brake or clutch) are equally possible, and a combination of radial and circumferential gaps may also be utilized.

1. A rotary coupling comprising a drive member and a reaction member having a gap therebetween, a magnetically reactive fluid in said gap, and apparatus for producing an altered magnetic field capable of changing the state of said fluid so as to transmit increased torque from said drive member to said reaction member on demand, wherein said coupling further includes a disengageable clutch in series with said drive member and operable on demand to obviate torque transmission from drive member to said reaction member.

2. A coupling according to claim 1 wherein said reaction member is a driven member of a shaft drive.

3. A coupling according to claim 1 wherein apparatus comprises an electrical coil which is energizable on demand to create an altered magnetic field.

4. A coupling according to claim 1 wherein said apparatus includes a movable permanent magnet to create an altered magnetic field.

5. A coupling according to claim 1 wherein said clutch is in said drive member.

6. A coupling according to claim 1 wherein said clutch is a digital clutch.

7. A coupling according to claim 6 wherein said clutch is a wrap spring.

8. A coupling according to claim 7 wherein said wrap spring has a grounding element engageable on demand.

9. A coupling according to claim 8 wherein said wrap spring closely surrounds said drive shaft, and said grounding element comprises an annulus rotatable about said shaft and engaged with a tang of said spring, said annulus being engageable on demand to ground in order to effect tightening of said wrap spring.

10. A coupling according to claim 9 wherein said annulus is of ferro-magnetic material, and an electro-magnetic coil is provided about said drive shaft and operable to urge said annulus into frictional contact with a ground.

11. A coupling according to claim 1 and further including a reservoir for said fluid, and a collection device adapt to urge on demand substantially all of said fluid from said gap into said reservoir.

12. A coupling according to claim 11 wherein said collection device is adapted to generate a magnetic attraction field in said reservoir.

13. A coupling according to claim 12 wherein said collection device comprises a deflector pivotable on demand from an inactive condition in which said fluid is undisturbed in said gap, to an active condition in which fluid is deflected into said reservoir during relative rotation between said drive member and reaction member.

14. A coupling according to claim 13 wherein said deflector is mounted on said reaction member and resilient means are provided to bias said deflector to the inactive condition.

15. A coupling according to claim 2 wherein apparatus comprises an electrical coil which is energizable on demand to create an altered magnetic field.

16. A coupling according to claim 2 wherein said apparatus includes a movable permanent magnet to create an altered magnetic field.

17. A coupling according to claim 3 wherein said apparatus includes a movable permanent magnet to create an altered magnetic field.
